(19) United States
(12) Patent Application Publication
(10) Pub. No.: US 2009/0253296 A1
(43) Pub. Date: Oct. 8, 2009

(54) Electrical card connector with improved card locking arm for holding an inserted card

(75) Inventors: Fang-Yue Zhu, Kunshan (CN); Qi-Jun Zhao, Kunshan (CN); Hua Yin, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/384,748

(22) Filed: Apr. 8, 2009

(30) Foreign Application Priority Data
Apr. 8, 2008 (CN) 200820035035.9

(51) Int. Cl. H01R 13/648; H01R 24/00

(52) U.S. Cl. 439/607.31; 439/630

(57) ABSTRACT

An electrical card connector for insertion of a card includes an insulative housing, a plurality of contacts and a push-push mechanism. The insulative housing defines a card receiving space and a side wall which includes a resistance wall and a notch located forward the resistance wall. The push-push mechanism includes a locking arm including a hook deformable in the notch and an engaging portion extending from the hook. When the card is fully inserted into the card receiving space to reach a final locking position, the hook locks with the depression of the card. When pulling out the card under such final locking position, the engaging portion abuts against the resistance wall for preventing the card from withdrawing from the card receiving space.

### BACKGROUND OF THE INVENTION

1. Field of the Invention

The present invention relates to an electrical card connector, more particularly to an electrical card connector with an improved card locking arm for holding an inserted card in final locking/working position.

2. Description of Related Art

Electrical card connectors are usually mounted on a PCB of the electronic devices to establish data transmission between the electrical cards and the electronic devices. Usually, an electrical card connector sets a locking arm for holding the inserted electrical card in locking position. Such current electrical card connector includes an insulative housing, a plurality of contacts fixed in the insulative housing, a push-push mechanism and a metal shell covering the insulative housing. The push-push mechanism includes a slider moveable along the card insertion direction and a locking arm retained on the slider. When the corresponding electrical card is inserted into the memory card connector, a hook of the locking arm is deformable to recess into a notch of the card in order to preliminarily hold the electrical card. With further insertion of the electrical card to reach the final locking position, contact pads of the electrical card abut against the contacts to establish electrically and mechanically connection. Under this condition, the electrical card is hold only via the locking arm abuts against the notch of the electrical card. However, since there is no other structure resisting and restricting deformation of the locking arm, the hook may easily withdraw from the notch of the electrical card under certain out force. As a result, the working electrical card can be easily pulled out from the electrical card connector under some error operations, which may destroy the electrical card.

Hence, an improved electrical card connector with improved card locking arm is needed to solve the problem above.

### BRIEF SUMMARY OF THE INVENTION

An electrical card connector for insertion of a card with a depression defined on a lateral side thereof includes an insulative housing, a plurality of contacts retained in the insulative housing and a push-push mechanism. The insulative housing includes an insertion opening, a card receiving space recessed from the insertion opening and a side wall located at a lateral side of the card receiving space. The side wall includes a resistance wall and a notch located forward the resistance wall. Each contact includes a contact portion extending into the card receiving space for mating with the card. The push-push mechanism includes a slider mounted on the side wall and a locking arm fixed on the slider. The locking arm has a hook deformable in the notch and an engaging portion extending from the hook. When the card is fully inserted into the card receiving space to reach a final locking position, the hook locks with the depression of the card. If pulling out the card under such final locking position, the engaging portion abuts against the resistance wall for preventing the card from withdrawing from the card receiving space.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical card connector according to the preferred embodiment of the present invention;

FIG. 2 is a part exploded view of the electrical card connector;

FIG. 3 is an exploded view of the electrical card connector;

FIG. 4 is another exploded view of the electrical card connector, but viewed from another aspect;

FIG. 5 is a perspective view of a slider and a locking arm of the electrical card connector;

FIG. 6 is a cross-sectional view of the electrical card connector showing the electrical card just inserted into the electrical card connector;

FIG. 7 is a cross-sectional view of the electrical card connector showing the locking arm recessed into the electrical card in preliminary locking status; and

FIG. 8 is a cross-sectional view of the electrical card connector showing the electrical card fully inserted into the electrical card connector in final locking status.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

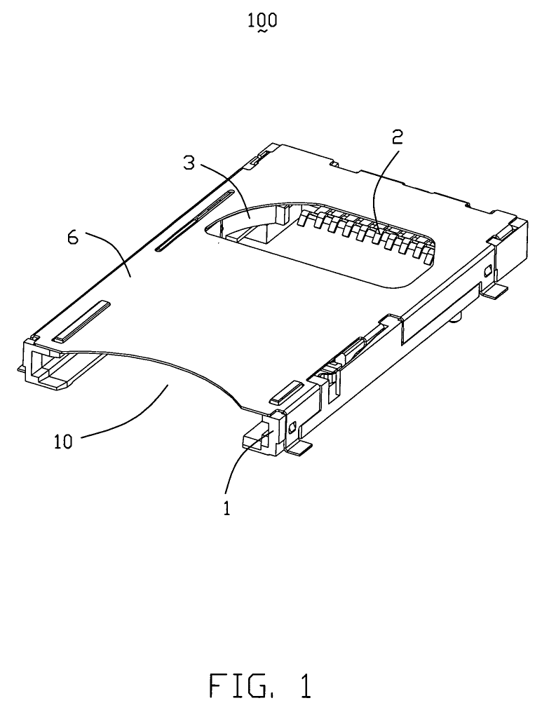

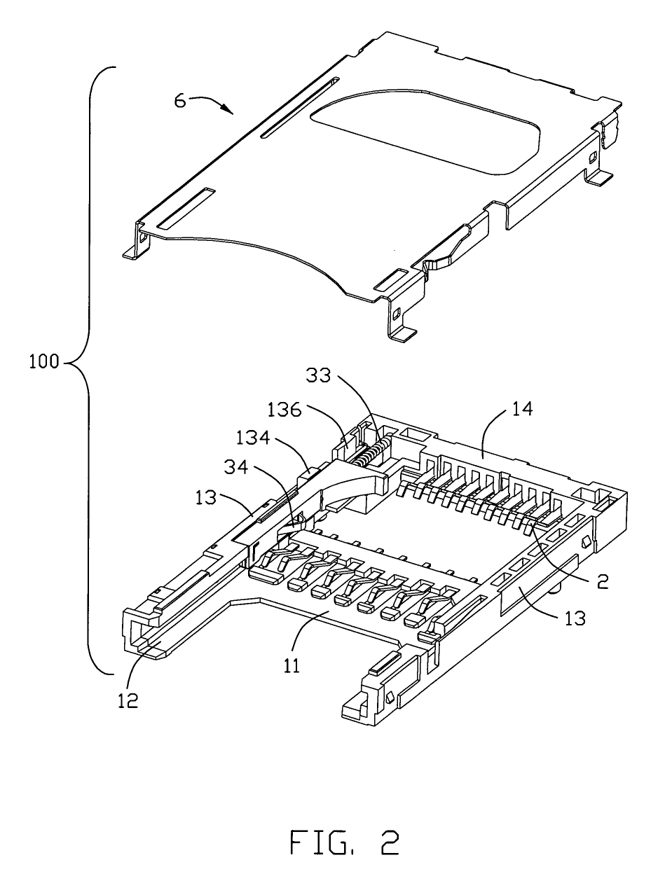

Referring to FIGS. 1-2, an electrical card connector 100 for insertion of an electrical card 8 is disclosed. The electrical card connector 100 includes an insulative housing 1, a plurality of contacts 2 retained in the insulative housing 1, a push-push mechanism 3 and a metal shell 6 covering the insulative housing 1. The metal shell 6 is attached to the insulative housing 1 to form a card receiving space 10 for receiving the electrical card 8. However, the card receiving space 10 can be defined only by the insulative housing 1.

The insulative housing 1 includes a bottom wall 11, an insertion opening 12 defined at a front end of the bottom wall 11, a sidewall 13 extending upwardly from a left side of the bottom wall 11, and a rear wall 14 opposite to the insertion opening 12. The card receiving space 10 is recessed rearwardly from the insertion opening 12. The side wall 13 defines a receiving chamber 131 communicating with the card receiving space 10 and a protrusion post 132 forwardly extending into the receiving chamber 131. The side wall 13 includes a first resistance wall 134, a second resistance wall 133 and a notch 135 located between the first and the second resistance walls 134, 133. The notch 135 is in communication with the receiving chamber 131.

The contacts 2 are arranged in two rows along the card insertion direction. The contacts 2 located at the rear row are adapted for mating with electrical card 8 and the contacts 2 located at the front row are adapted for mating with another electrical card (not shown). Each contact 2 includes a contact portion 21 cantileveredly extending into the card receiving space 10 and a tail portion 22 for being mounted on a print circuit board.

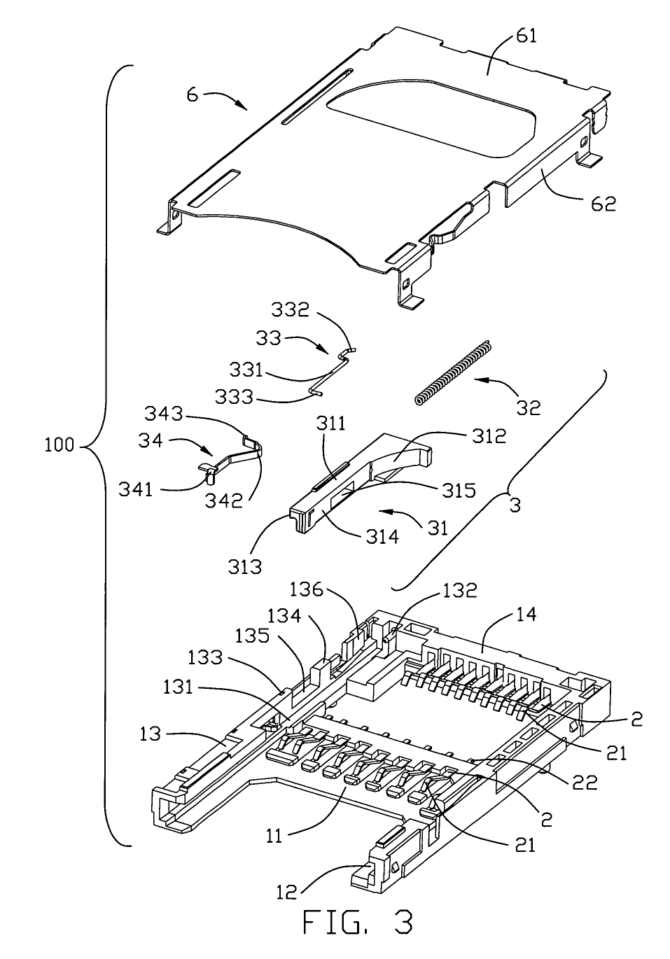

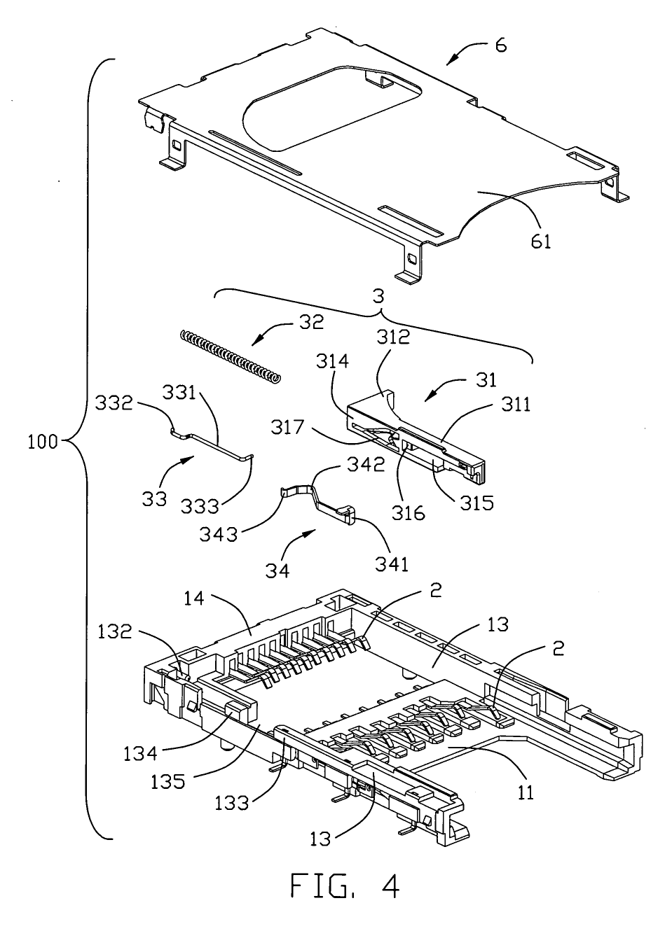

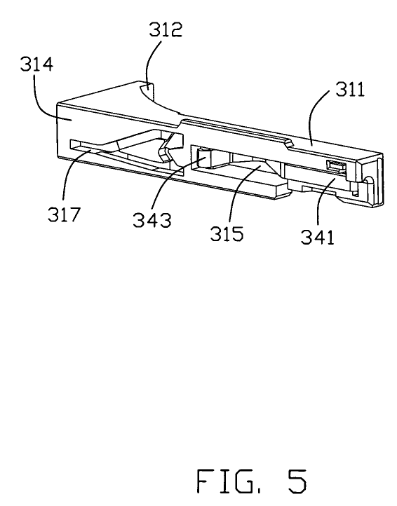

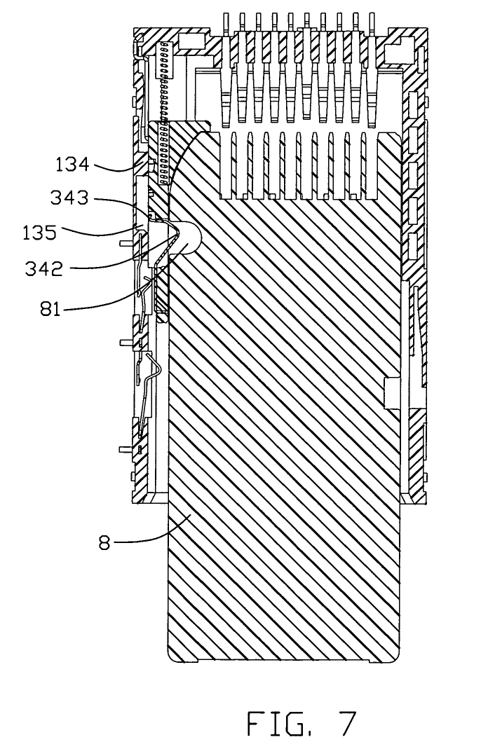

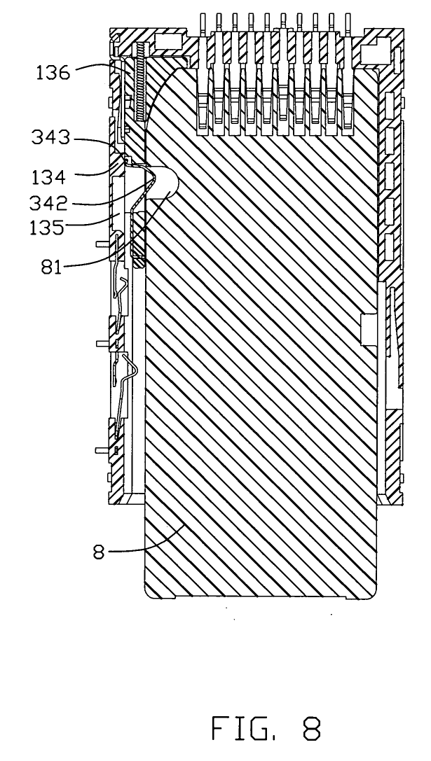

Referring to FIGS. 3 to 8, the card eject mechanism 3 includes a slider 31 moveable in the receiving chamber 131, a coiled spring 32 abutting against the slider 31, and a link rod 33 for controlling positions of the slider 31. The slider 31 includes a guiding portion 311 attached to the first and the second resistance walls 134, 133 and a protrusion 312 sidewardly extending into the card receiving space 10. The guiding portion 311 includes opposite first and second side surfaces 313, 314 and a through hole 315 extending through the first and second side surfaces 313, 314. The first side surface 313 is attached to the first and the second resistance walls 134, 133 for stably insertion of the electrical card 8 into the card receiving space 10. A heart-shaped cam 317 is recessed through the first side surface 313 and is located rearward the through hole 315. The slider 31 further includes a locking arm 34 for mating with the electrical card 8. The locking arm 34 includes a retaining portion 341 fixed in the slider 31, an arc hook 342 extending from the retaining portion 341, and an engaging portion 343 integrally extending from the hook 342. The engaging portion 343 is located at a free end of the hook 342. The hook 342 is partly received in the through hole 315 and partly protrudes into the card receiving space 10 through the second side surface 314. The hook 342 and the engaging portion 343 forms a cantilevered arm with great elasticity. The slider 31 further includes a mating portion 316 in the through hole 315 for abutting against the engaging portion 343 to prevent inwardly over-deformation of the locking arm 34.

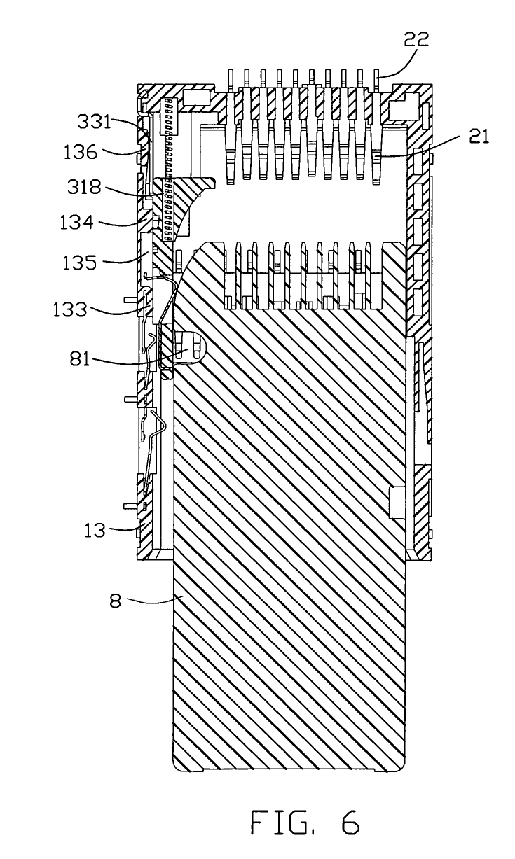

One end of the coiled spring 32 is assembled to the protrusion post 132 and the other end of the coiled spring 32 is received in a receiving hole 318 of the slider 31, as best shown in FIG. 6. The coiled spring 32 gives the slider 31 elastic force to realize ejecting the electrical card 8 from the electrical card connector 100.

The link rod 33 includes a middle portion 331, a first end portion 332 and a second end portion 333 sidewardly bending from opposite ends of the middle portion 331. The middle portion 331 is outwardly restricted by a pressing wall 136 of the side wall 13 for retaining purpose. The second end portion 333 is moveable in the heart-shaped cam 317. The electrical card connector 100 is so-called push-push type card connector and the working theory of the push-push mechanism 3 is obvious to those of ordinary skill in the art, so the detailed description is omitted hereinafter.

The metal shell 6 is stamped from a metal sheet and includes a top wall 61 and a pair of bending walls 62 extending downwardly from lateral sides of the top wall 61.

Referring to FIGS. 6 to 8, when the electrical card 8 is just inserted into card receiving space 10 through the insertion opening 12, the hook 342 is directed driven by the electrical card 8 to be outwardly deformable into the notch 135. With further insertion of the electrical card 8 into the card receiving space 10, the hook 342 locks with a depression 81 formed in a lateral side of the electrical card 8 to hold the electrical card 8 in a preliminary locking position. The front portion of the electrical card 8 abuts against the protrusion 312 of the slider 31 and drives the slider 31 moveable backwardly. The middle portion 331 is outwardly restricted by a pressing wall 136 of the side wall 13 in order to prevent the link rod 33 from falling off the side wall 13. Under such process, the second end portion 333 is moveable in the heart-shaped cam 317. When the electrical card 8 is further inserted into the card receiving space 10 and reach the final locking/working position, the second end portion 333 reaches a locking location of the heart-shaped cam 317. As a result, the engaging portion 343 backwardly extends beyond the notch 135.

According to the preferred embodiment of the present invention, even if the electrical card 8 is pulled outwardly from the card receiving space 10 under error operations when the electrical card 8 is located at the final locking position, the electrical card 8 can't withdraw from the card receiving space 10 as well because the engaging portion 343 abuts against the first resistance wall 134 along a lateral direction of the insulative housing 1. As a result, deformation of the locking arm 34 is restricted and the hook 342 always locking with the depression 81 of the electrical card 8 under such error operations. However, with further push of the electrical card 8 into the card receiving spacer 10, the electrical card 8 can withdraw from the card receiving space 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

We claim:

1. An electrical card connector for insertion of a card with a depression defined on a lateral side thereof, comprising:
an insulative housing defining an insertion opening, a card receiving space recessed from the insertion opening and a side wall located at a lateral side of the card receiving space, the side wall comprising a resistance wall and a notch located forward the resistance wall;
a plurality of contacts retained in the insulative housing with contact portions extending into the card receiving space for mating with the card; and
a push-push mechanism comprising a slider mounted on the side wall and a locking arm fixed on the slider, the locking arm having a hook deformable in the notch and an engaging portion extending from the hook under a condition that when the card is fully inserted into the card receiving space to reach a final locking position, the hook locks with the depression of the card; and wherein the engaging portion abuts against the resistance wall for preventing the card from withdrawing from the card receiving space if pulling out the card under such final locking position.

2. The electrical card connector as claimed in claim 1, wherein the slider comprises opposite first and second side surfaces and a through hole extending through the first and the second side surfaces in condition that the first side surface is attached to the side wall of the insulative housing, and the hook extends beyond the second side surface and further extends into the card receiving space.

3. The electrical card connector as claimed in claim 1, wherein the engaging portion extends from the hook and is located at a free end of the hook.

4. The electrical card connector as claimed in claim 1, wherein the engaging portion abuts against the resistance wall along a lateral direction of the insulative housing perpendicular to a card insertion direction to prevent the card from withdrawing from the card receiving space if pulling out the card under such final locking position.

5. The electrical card connector as claimed in claim 2, wherein the push-push mechanism comprises a coiled spring and a link rod, the coiled spring comprising one end abutting against the slider and the other end abutting against the insulative housing, and the link rod comprising one end portion retained in the insulative housing and the other end portion movable in a heart-shaped cam formed in the slider.

6. The electrical card connector as claimed in claim 5, wherein the heart-shaped cam is defined through the first side surface of the slider and is located rearward the through hole.

7. The electrical card connector as claimed in claim 5, wherein the link rod comprises a middle portion between the two end portions, and the side wall of the insulative housing comprises a pressing wall abutting against the middle portion.

8. The electrical card connector as claimed in claim 1, wherein the side wall defines a receiving chamber to accommodate the slider and for the slider moveable therein.

9. The electrical card connector as claimed in claim 1, further comprising a metal shell covering the insulative housing, the card receiving space being jointly defined by the metal shell and the insulative housing.

10. An electrical card connector for insertion of a card with a depression defined on a lateral side thereof, comprising:
an insulative housing defining a card receiving space and a side wall located at a lateral side of the card receiving space, the side wall comprising a resistance wall and a notch located forward the resistance wall;
a plurality of contacts with contact portions extending into the card receiving space for mating with the card;
a slider mounted on the side wall and comprising a first side surface attached to an inner side of the side wall, a second side surface opposite to the first side surface and a through hole extending through the first and the second side surfaces; and
a locking arm fixed on the slider, the locking arm having a hook received in the through hole and an engaging portion moveable in the notch; wherein
with insertion of the card into the card receiving space, the hook is deformable to lock with the depression of the card and the engaging portion is driven by the card to extend beyond the notch to finally abut against the resistance wall for preventing the card from withdrawing from the card receiving space.

11. The electrical card connector as claimed in claim 10, wherein the hook extends beyond the second side surface and further extends into the card receiving space for abutting against the card.

12. The electrical card connector as claimed in claim 10, wherein the engaging portion extends from the hook and is located at a free end of the hook.

13. The electrical card connector as claimed in claim 10, wherein the slider comprises a mating portion located in the through hole to abut against the engaging portion for preventing inwardly over-deformation of the locking arm.

14. The electrical card connector as claimed in claim 10, further comprising a coiled spring and a link rod, the coiled spring comprising one end abutting against the slider and the other end abutting against the insulative housing, and the link rod comprising one end portion retained in the insulative housing and the other end portion movable in a heart-shaped cam formed in the slider.

15. The electrical card connector as claimed in claim 14, wherein the heart-shaped cam is defined through the first side surface of the slider and is located rearward the through hole.

16. The electrical card connector as claimed in claim 14, wherein the link rod comprises a middle portion between the two end portions, and the side wall of the insulative housing comprises a pressing wall abutting against the middle portion.

17. The electrical card connector as claimed in claim 10, further comprising a metal shell covering the insulative housing, the card receiving space being jointly defined by the metal shell and the insulative housing.

18. An electrical connector comprising:
an insulative housing;
a metallic shell cooperating with the housing to define a card receiving cavity;
a plurality of contacts disposed in the housing with contacting sections extending into the card receiving cavity;
a side arm located on one lateral side of the card receiving cavity;
a slider moved along an inner side of the side arm in a front-to-back direction and defining a through hole in a lateral direction, a locking arm attached to the slider and laterally deflectably located in said through hole; wherein
said side arm defines a cutout to allow the locking arm to outwardly deflectably move when an electronic card is inserted into the card receiving cavity; wherein
said slider includes a top face to protectively hide the locking arm thereunder, and the locking arm is allowed to be only laterally assembled to the slider.

19. The electrical connector as claimed in claim 18, wherein said the shell defines a slit and the slider defines an upward protrusion to be received in said slit for guiding movement of the slider along said front-to-back direction.
